(19) United States
(12) Patent Application Publication
(10) Pub. No.: US 2006/0201727 A1
(43) Pub. Date: Sep. 14, 2006

(54) Rain gutter for a vehicle hood

(75) Inventor: Chung Chan, Diamond Bar, CA (US)

Correspondence Address: INTELLECTUAL PROPERTY LAW OFFICE OF JOEL VOELZKE, 400 CORPORATE POINTE, SUITE 300, CULVER CITY, CA, 90230, US

(73) Assignee: VIS Racing Sports, Inc.

(21) Appl. No.: 11/184,150

(22) Filed: Jul. 19, 2005

Related U.S. Application Data
(60) Provisional application No. 60/660,813, filed on Mar. 11, 2005.

(51) Int. Cl. B62D 25/10

(52) U.S. Cl. 180/69.25

(57) ABSTRACT

A rain gutter system for a vehicle hood includes a vehicle hood having an opening. A rain gutter is mounted to the hood underneath the opening. At least one contoured area is on at least one side of the rain gutter, wherein there is a space in between the contoured area and the hood, such that water may flow through the hood opening, along the rain gutter and out of the rain gutter at the space. The rain gutter may include a series of grooves or another pattern molded into the gutter. The hood may be made of a moldable material, with threaded members being molded into the hood. The rain gutter may be mounted with bolts or screws at the threaded members. A grill may be associated with the opening. The rain gutter may be molded and may be made of a moldable material, such as fiberglass, another composite, or a polymer.

### RELATED APPLICATIONS

This application claims priority from U.S. provisional patent application serial No. 60/660,813, filed Mar. 11, 2005.

### BACKGROUND OF THE INVENTION

1. Field of the Invention

This invention relates to the field of vehicle hoods. More particularly, this invention relates to the field of devices to prevent water from flowing through the hood and onto a portion of the engine block.

2. Description of Related Art

Decorative vehicle hoods may include various openings for either ornamental or functional purposes. One such functional purpose is to provide ports for the inflow of air for the engine to use. The ports may be open areas on the hood that simply allow air to flow through. To make the air ports have a pleasing appearance, a grill or other covering may be placed in or on top of an opening.

A problem may arise, however, when it is raining or when the hood otherwise gets wet. Water may flow into the air opening and onto the engine. Oftentimes there are sensitive electronics or other portions of the engine onto which one does not wish water to hit. Consequently, creating openings for air on the hood may result in allowing water to flow through the opening and onto the engine when that is not desirable. It may be preferable to direct the flow of water away from the engine or to another part of the engine.

In the past, attempts have been made to overcome this shortcoming by sealing the air openings entirely, thereby preventing water from hitting the engine but also preventing air from flowing in. The air openings have been sealed by a solid metal plate, for example. It would be preferable, however, to direct the flow of rain or other water without blocking the flow of air into the engine.

### SUMMARY OF THE INVENTION

In one embodiment of the present invention, a rain gutter system for a vehicle hood includes a vehicle hood having an opening. A rain gutter is mounted on the hood underneath the opening. There is at least one contoured area on at least one side of the rain gutter, wherein there is a space between the contoured area and the hood, such that water may flow through the hood opening, along the rain gutter and out of the rain gutter at the space.

According to other aspects of particular embodiments, the rain gutter may include a series of grooves. The hood may be made of a moldable material such as fiberglass or another durable moldable material, with members having threaded apertures molded into the hood. The rain gutter may be mounted by means of bolts and/or screws screwed into the threaded members, or other suitable fasteners. A grill may be associated with the opening to prevent foreign objects such as leaves from entering the opening and/or for aesthetic effect. The rain gutter may also be molded out of a moldable material such as fiberglass or another durable material.

According to another embodiment, a rain gutter system includes a vehicle hood having an opening, the hood being adapted to be mounted on a vehicle such that the opening is over an engine block. A rain gutter may be mounted on the hood and underneath the opening. There is at least one space at an edge of the rain gutter to allow water to run out the rain gutter at the edge and away from the engine block.

In another embodiment, a rain gutter system includes a vehicle hood having an opening. A rain gutter is mounted on the hood and underneath the opening. The system includes means for causing water that flows through the opening onto the rain gutter to run out at least one portion of one side of the rain gutter. This means may include one or more openings between the rain gutter and the hood when the rain gutter is mounted on the hood, and may also optionally include contouring on the rain gutter, a slope of the rain gutter, slits, and the like.

Exemplary embodiments of the invention will be further described below with reference to the drawings in which like numbers refer to like parts. The invention is not limited to what this Summary describes. Rather, reference should be made to the claims, the specification, and the drawings to fully appreciate the scope of the invention.

### BRIEF DESCRIPTION OF THE DRAWINGS

FIG. 1 is a perspective view of the top of one embodiment of a vehicle hood;

FIG. 2 is a view of the underside of the automobile hood of FIG. 1;

FIG. 3 is a close-up view of the grill under which the rain gutter is mounted, with the rain gutter removed;

FIG. 4 is a cross-section taken about Line 4-4 of FIG. 2; and

FIG. 5 is a top view of the rain gutter as it appears when not mounted on the hood.

### DETAILED DESCRIPTION OF THE PREFERRED EMBODIMENTS

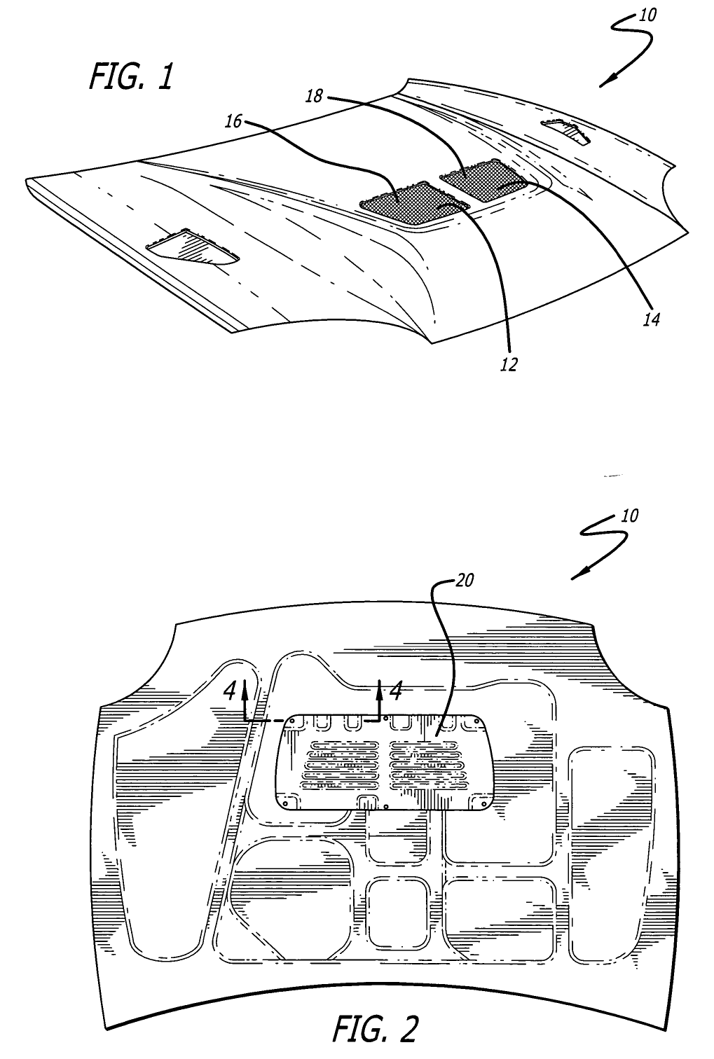

With reference to FIG. 1, a hood 10 has various features. One set of such features is openings 12 and 14 which may be positioned over the engine block when the hood is mounted on a vehicle. The openings 12 and 14 may be covered with respective grills 16 and 18. The hood may be formed from metal, but is more typically formed from a moldable material such as fiberglass and/or another composite or a strong polymer.

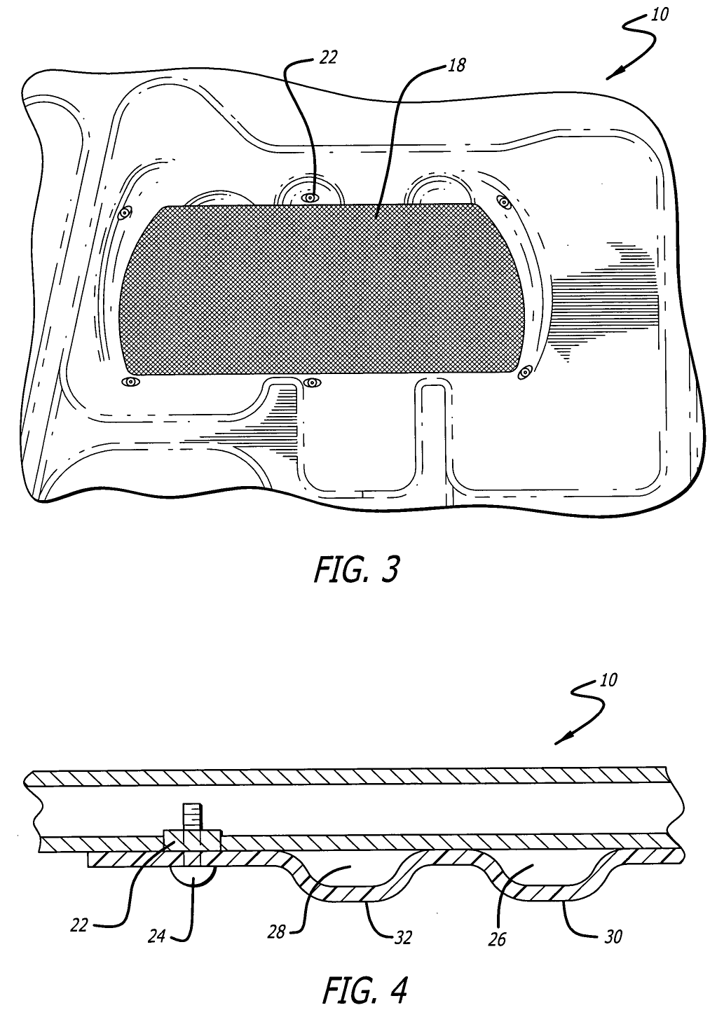

FIG. 2 illustrates the underside of the hood 10 of FIG. 1. A substantially planar member 20 defining a rain gutter is mounted onto the hood directly beneath the openings 16 and 18 of the hood 10. The rain gutter 20 is mounted to the hood 10 via bolts, screws, or other suitable fasteners. Rain gutter 20, being larger than openings 12 and 14 and affixed to the underside of the hood, substantially completely blocks any passage of water through openings 12 and 14 from directly above directly into the engine compartment without first being diverted. At the same time, rain gutter 20 is shaped and affixed to the underside of hood 10 in such a way that a substantial flow of air can still enter the engine compartment through openings 12 and 14, thus providing substantial ventilation for the engine compartment. FIG. 3 shows the rain gutter removed thereby revealing special threaded apertures such as apertures 22 that are molded into the hood. These receive the bolts and/or screws used to attach the rain gutter to the hood. FIG. 4 further illustrates this concept, with rain gutter 20 being attached to the hood 10 with bolts such as bolt 24 threaded through threaded apertures such as 22, which are molded into the hood. Other fastening methods may be used including rivets and clips. Although hood 10 is shown in FIG. 4 as being double walled and hence bolt 24 can extend into hood 10, alternatively fastening lugs for screws, clips, and the like can be mounted to the surface of a single walled or a double walled hood via adhesives, welding, or the like.

In the embodiment of FIG. 4, the rain gutter has contoured portions to form apertures 26 and 28 along one edge thereof. The contours themselves may be numbered 30 and 32. These apertures allow water to flow out the side edge of the rain gutter. The water will then tend to fall away from the engine block, which may have water-sensitive electronics mounted thereon and/or may be very hot from operation of the engine. Consequently, the rain gutter re-directs the water away from the engine block, a portion thereof, or from other water-sensitive areas.

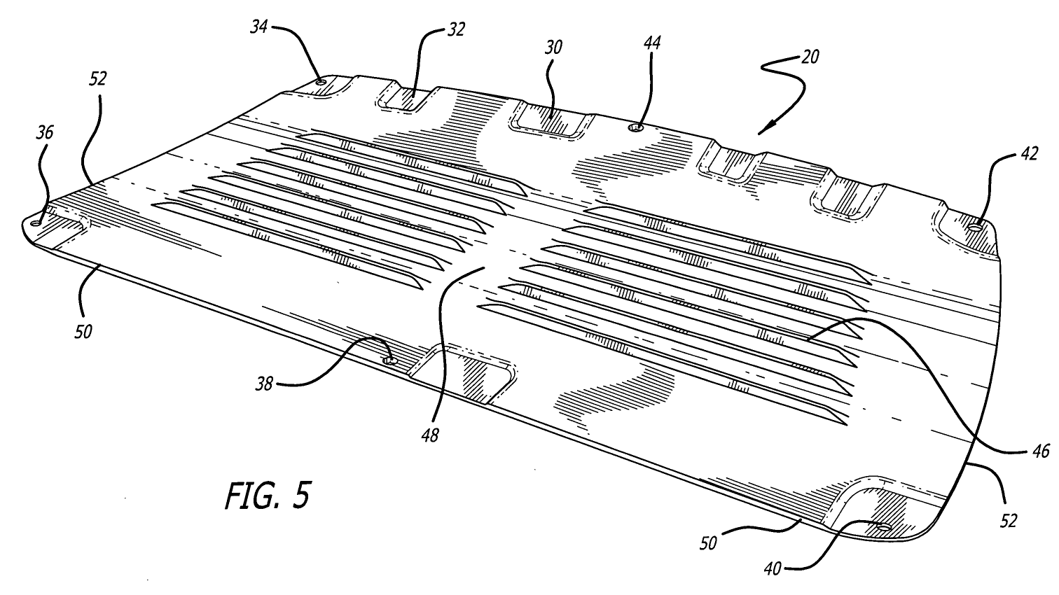

The rain gutter is shown in isolation in FIG. 5 with multiple contoured areas such as 30 and 32. The rain gutter includes bolt openings 34, 36, 38, 40, 42 and 44, through which bolts or screws may extend to secure the rain gutter to the hood. The rain gutter of FIG. 5 is only one example, and a particular rain gutter may include additional features as desired by the designer. In the particular embodiment shown in FIG. 5 the rain gutter includes ridges 46. These ridges may be functional, as for example for the purpose of directing water off of the rain gutter, or they may be largely decorative. For example, the ridges may be visible when the hood is viewed from the front, through the grill 18 giving a pleasing aesthetic effect. However, it will be understood that the rain gutter may be contoured in such a way so as to encourage the flow of water from the center portion of the rain gutter to the edges, where the water may flow out. Also, the edges may be curved (in ways other than the contoured areas 30 and 32, for example), to create spaces between the rain gutter and the hood through which the water may run out.

In another embodiment, ridges 46 may extend through center section 48, thus completely channeling water out to the sides of the engine compartment and completely away from the engine block, such that the water exits at points 50 along the rear edge of rain gutter 20 and towards its sides. In still another embodiment, the rain gutter may include concave channels and/or raised ridges that completely channel the water to points 52 along the side edges of rain gutter 20. In a still further embodiment, the rain gutter may include concave channels rather than the raised ridges 46 illustrated. In a still further embodiment, ridges 46 or channels may arc toward the rear, thus channeling water simultaneously both toward the rear and toward the sides of rain gutter 20. In a still further embodiment, ridges 46 and/or channels may by shaped so as to direct substantially all water which enters the engine compartment area through openings 12 and 14 from above toward a single exit point, thus channeling the water away from the engine block and to a place within the engine compartment where that water is highly unlikely to cause any damage.

It will be appreciated that the term “present invention” as used herein should not be construed to mean that only a single invention having a single essential element or group of elements is presented. Similarly, it will also be appreciated that the term “present invention” may encompass a number of separate innovations which can each be considered separate inventions. Although the present invention has thus been described in detail with regard to the preferred embodiments and drawings thereof, it should be apparent to those skilled in the art that various adaptations and modifications of the present invention may be accomplished without departing from the spirit and the scope of the invention. Accordingly, it is to be understood that the detailed description and the accompanying drawings as set forth hereinabove are not intended to limit the breadth of the present invention, which should be inferred only from the following claims and their appropriately construed legal equivalents.

We claim:

1. A rain gutter system for a vehicle hood, comprising:
a vehicle hood having an opening;
a rain gutter mounted on the hood and disposed underneath the opening; and
at least one contoured area on at least one side of the rain gutter, wherein there is a space between the contoured area and the hood such that water may flow through the hood opening, along the rain gutter and out of the rain gutter at the space.

2. The system of claim 1, wherein the rain gutter includes a plurality of grooves.

3. The system of claim 1, wherein the hood comprises a moldable material and threaded members are molded into the hood.

4. The system of claim 3, wherein the rain gutter is mounted with at least one of bolts and screws at the threaded members.

5. The system of claim 1, wherein the hood includes a grill associated with the opening.

6. The system of claim 1, wherein the rain gutter is molded.

7. The system of claim 1, wherein the rain gutter comprises fiberglass.

8. A rain gutter system for a vehicle hood that is to be mounted on a vehicle, comprising;
a vehicle hood having an opening, the hood being adapted to be mounted on a vehicle such that the opening is disposed over at least a portion of an engine block;
a rain gutter mounted to the hood and disposed underneath the opening; and
a space at an edge of the rain gutter to allow water to run out the rain gutter at the edge and away from the engine block.

9. The system of claim 8, wherein the rain gutter includes a plurality of grooves.

10. The system of claim 8, wherein the hood comprises a moldable material and threaded members are molded into the hood.

11. The system of claim 8, wherein the rain gutter is mounted with at least one of bolts and screws at the threaded members.

12. The system of claim 8, wherein the hood includes a grill associated with the opening.

13. The system of claim 8, wherein the rain gutter is molded.

14. A rain gutter system for a vehicle hood, comprising:
a vehicle hood having an opening;
a rain gutter mounted on the hood and disposed underneath the opening; and
means for causing water that flows through the opening onto the rain gutter to run out at least one portion of one side of the rain gutter.

15. The system of claim 14, wherein the hood comprises a moldable material and threaded members are molded into the hood.

16. The system of claim 15, wherein the rain gutter is mounted with at least one of bolts and screws at the threaded members.

17. The system of claim 14, wherein the rain gutter is molded and has contours at the edges.

18. A hood system for a vehicle, the vehicle including an engine compartment and an engine, comprising:
a hood having at least one opening therein, the hood having an underside facing the engine when the hood is installed in the vehicle, the opening being disposed at least partially over the engine block;
a generally planar member affixed to the hood underside, the member being shaped and held is such relationship to the hood as to allow a substantial amount of air to flow through the hood opening for ventilating the engine compartment; and
wherein the member covers at least a portion of the engine block such that water entering the engine compartment through the hood opening is generally prevented from running directly onto the engine block.

19. The hood system of claim 18 wherein the member is larger than the hood opening and completely covers said hood opening from said underside, thereby redirecting water which enters the hood opening from above away from the engine block.

20. The hood system of claim 18 wherein the member has at least one shaped feature that directs substantially all water which enters through the hood opening from above to a single exit point away from the engine block.
